(19) United States
(12) Patent Application Publication
(10) Pub. No.: US 2022/0342984 A1
(43) Pub. Date: Oct. 27, 2022

(54) INTEGRITY MONITOR

(71) Applicant: Hewlett-Packard Development Company, L.P., Spring, TX (US)

(72) Inventors: Maugan Villatel, Bristol (GB); David Plaquin, Bristol (GB); Christopher Ian Dalton, Bristol (GB)

(73) Assignee: Hewlett-Packard Development Company, L.P., Spring, TX (US)

(21) Appl. No.: 17/761,694

(22) PCT Filed: Oct. 25, 2019
(86) PCT No.: PCT/US2019/058071

§ 371 Date: Mar. 18, 2022

(51) Int. Cl. G06F 21/55

(52) U.S. Cl. CPC G06F 21/55

(57) ABSTRACT

There is described a method including obtaining memory management configuration data, for example, from a memory management unit. The memory management configuration data is used to identify memory locations having a predetermined property. Content is monitored at the identified memory locations.

### BACKGROUND

Antiviruses today are focused on preventing infection (e.g. scanning files before opening them) and detecting malicious user-space processes. Monitoring within a kernel may be possible relying on some form of software obfuscation to protect a monitoring component from a successful intrusion.

### BRIEF DESCRIPTION OF THE DRAWINGS

Various features and advantages of certain examples will be apparent from the detailed description which follows, taken in conjunction with the accompanying drawings, which together illustrate, by way of example, a number of features, and wherein:

FIG. 1 is a schematic diagram showing a paged memory structure according to an example;

FIG. 2 is a schematic diagram showing a page table according to an example;

FIG. 3 is a flowchart of a method for monitoring a memory according to an example;

FIG. 4 is a further flowchart showing a method of monitoring content at identified memory locations according to an example;

FIG. 5 is a schematic showing components of a monitor according to an example;

FIG. 6 is a schematic showing an example implemented with a system having a secure (e.g. secure world) and non-secure (e.g. normal world) portion;

FIG. 7 is a block diagram showing components of a processor and memory according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Kernel space has historically been a blind spot for security, both because it is more difficult to monitor it but also because there is absolutely no separation between drivers (whereas there is some between processes) it would be difficult for a monitor to protect itself against a successful kernel-level infection. Further, software obfuscation of a monitoring component may be susceptible to skilled attackers able to reverse engineer the obfuscation mechanism and compromise the monitoring component itself as part of the intrusion. Thus, it is difficult to effectively monitor a computer system to detect and mitigate malicious kernel-level attacks. As will be explained, according to examples, the integrity of the kernel code portions may be protected by using the processor's page tables as defined by a memory management unit, it is possible to find all the locations of the kernel code, and monitor it for unexpected changes. In one example, the monitoring is performed by taking a hash of the content at the identified locations and comparing it with a hash taken at an earlier time, such as at boot time, when the system is assumed not to be compromised.

In examples, a more privileged component (e.g. hypervisor, TrustZone, SMM) may carry out the runtime monitoring checks to protect the integrity of the code executed by the kernel layer. This protects against some of the most powerful and simple infections of kernel space: code injection and code modification.

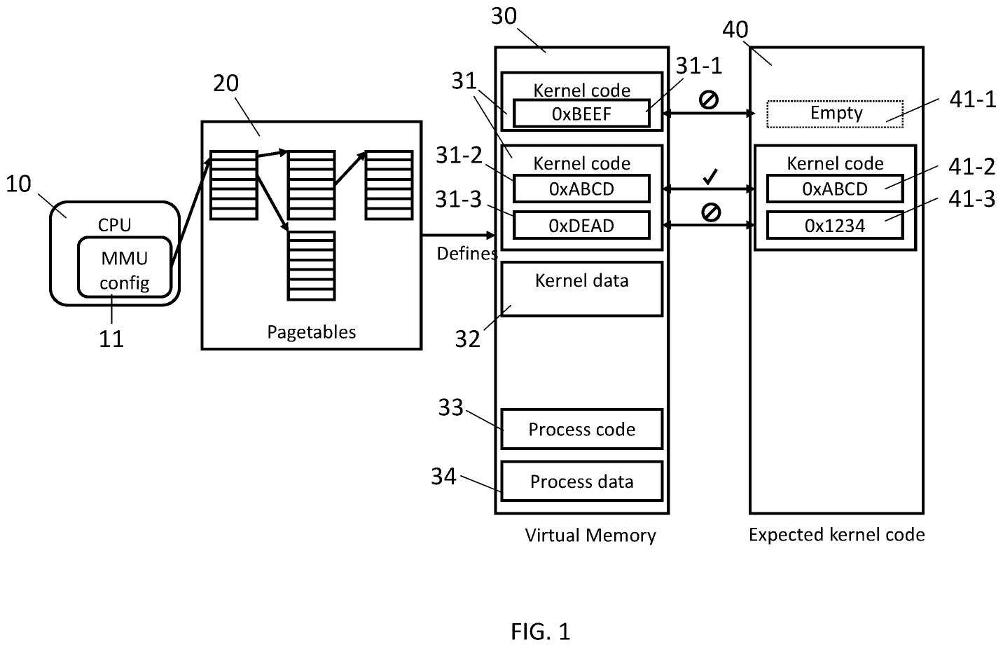

FIG. 1 is a schematic diagram showing a processor (CPU) 10 with a memory management unit (MMU) 11. In this example, the MMU is shown as being a component on board the CPU. It will be appreciated that in other architectures the MMU may be a separate component, however, in communication with one or more cores of a CPU. The MMU has a number of configuration registers which define the root of the page tables 20. The page tables may form a multi-level or hierarchical page structure such that a level 1 entry points to a level 2 table and so on. The page tables 20 contain page table entries that map frames of memory in a virtual address space 30 to a physical address space (not shown), for example, a main memory (RAM or cache memory). Where the tables are hierarchically structured, it is possible to set a page table entry attribute (examples of which will be described below) on e.g. a level 1 entry, and it will “force” the attribute on all subsequent levels pointed to by the level 1 entry.

Different types of data may be addressed within the virtual memory 30. For example, the virtual memory may include kernel code 31, kernel data 32, process code 33 and process data 34. Kernel code relates to kernel executable areas of memory and kernel data 32 relates to data used by the kernel processes (i.e. core processes of an operating system) run by executing the code 31. The process code 33 relates to other processes (e.g. from applications) running in the virtual memory space and process data 34 relates to data used in execution of those processes. Kernel code 31 is of particular interest as intrusion into these areas of memory may compromise the O/S running on the processor.

The kernel code locations 31 contain data which should not be unknowingly changed during running of the O/S. As will be explained in more detail below if these (or other sensitive) memory locations can be efficiently identified then they can be monitored for unexpected changes. In an example, one way to monitor for changes is to take a hash of the content at a time when it is believed that the content has not been compromised and then take a hash at a later time and compare the obtained hash values. If they are different then the kernel executable memory location has potentially been compromised and it may then be determined if an appropriate mitigating action is to be taken in response. The hash values taken at a time when the kernel memory is deemed to be uncompromised may be stored in a reference list 40 which contains the hashes 41-2 and 41-3 for corresponding kernel code locations 31. In the example shown, a measured hash value 31-2 and 31-3 corresponding to the addresses of the reference hashes 41-2 and 41-3 show that the reference hash 41-3 does not correspond to the measured hash 31-3. This indicates that the code has been changed which should not happen during normal operation and may indicate the kernel has been compromised. Further a measured hash 31-1 of an executable kernel memory location is found to contain code wherein the reference list is was deemed empty 41-1. This indicated some new executable code has been added to the kernel which will need to be considered by any monitoring component of the system.

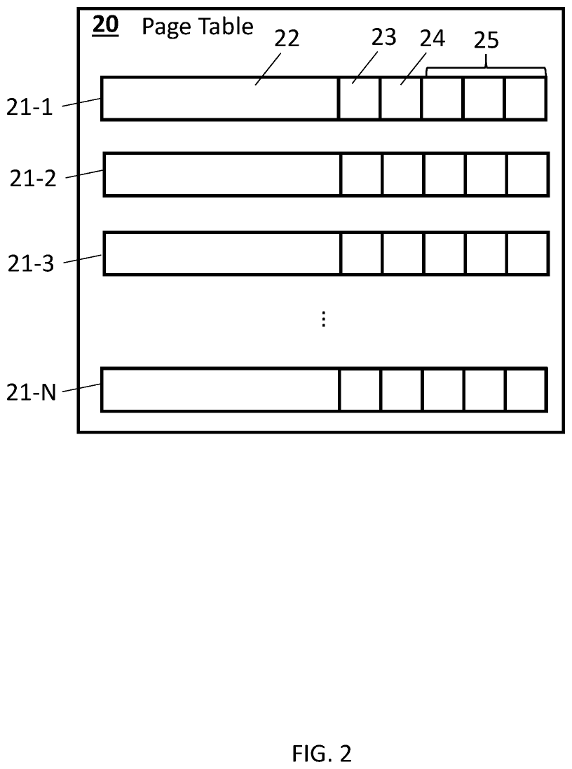

An example of a page table 20 is shown schematically in FIG. 2. The page table 20 contains multiple indexed entries 21-1 to 21-N. An entry 21-1 to 21-N includes a physical address 22 for mapping the virtual address indicated by the page table entry to a physical address in memory and a number of status bits indicating properties of the frame of memory to which the page table entry pertains. For example, the attribute bits may include a PXN “Privileged Execute Never” bit 23 which is a flag that when set prevents code (i.e. kernel code) from executing in that page. Other attribute bits may include a read/write bit 24 which indicates whether the memory at the page may be written to or is “read only”. A “read only” attribute may be an indicator of sensitive code which should not be able to be changed. Other types of attribute bits 25 may be possible describing other attributes of the page in memory and these could be used in examples to identify code of a certain attribute which is to be monitored.

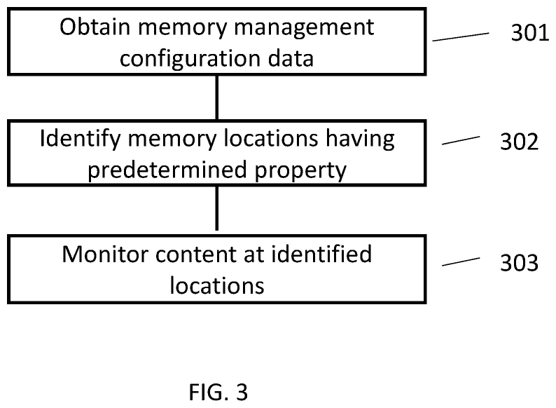

FIG. 3 shows a method for identifying and monitoring memory locations of interest according to an example. In a block 301, memory management configuration data is obtained. This may be obtained from the configuration registers of the MMU and provide page table data and attributes. The page table data structures may then be used to identify at block 302 memory locations within the virtual memory space having a predetermined property. As mentioned, the predetermined property may be that the memory location is executable by the kernel, in other words contains privileged code. Another possible property might be that the memory location is “read only”. The identification may be performed, for example, by inspecting the attribute/status bits of a page table entry for a frame of memory and determining from the attributes whether the frame of memory has the predetermined property. If a given address is not marked as executable in the page tables, then trying to execute it will raise a CPU exception. Thus, the attributes give an authoritative view of what is currently executable e.g. by the kernel.

For example, to find all privileged code, the page tables in use by the processor may be checked. All virtual addresses may be iterated starting from address 0 up to the top of the address space and the permission checks that the processor typically performs in hardware may be emulated for this virtual address. For example, the “Privileged Execute Never” (PXN) bit, that prevents (i.e. kernel) code from executing code in those pages will be inspected. Any page that does not have this bit will be considered as containing executable code. For example, versions of the Linux operating system started to set this attribute on all non-kernel code (e.g. regions of memory containing data or code that is not executable by a kernel). The physical address of all executable pages can be obtained from the page table, so we can find the content of the page in physical memory. Using this technique, the method can thus find all kernel-executable virtual pages and their corresponding physical addresses. Where hierarchical page tables are used, where the PXN bit is set on a upper-level entry (e.g. level 1) it may be forced on all page table entries in a lower-level entry (e.g. level 2) to which the upper-level entry points. Thus, whether kernel executable code is present at regions of virtual memory of the lower level table may be determined by looking at the attribute(s), e.g. the PXN bit, of the upper level page table entry.

Checks may be performed on the executable pages found. It may be verified that no executable page has been added and that virtual to physical mappings have not changed. A page is considered “added” when a virtual address that did not contain kernel executable code at boot time suddenly contains kernel executable code. A check may be made that for each “known” executable page and verify that its corresponding physical address is still the same as it was at boot time.

At block 303, the content at the identified memory locations is monitored. For example, the monitoring may ensure that:
no unauthorized code has been added to the executed code;
no existing code has been modified since it was verified and authorized to be executed (either during the boot or the setup of the platform).

According to the method at block 302, a monitoring component is able to assemble the list of executable pages (or other pages of interest). One way of monitoring according to an example is to compare content of those code pages from a time at which the content was trusted to another time when it is not known whether the code pages have been tampered with.

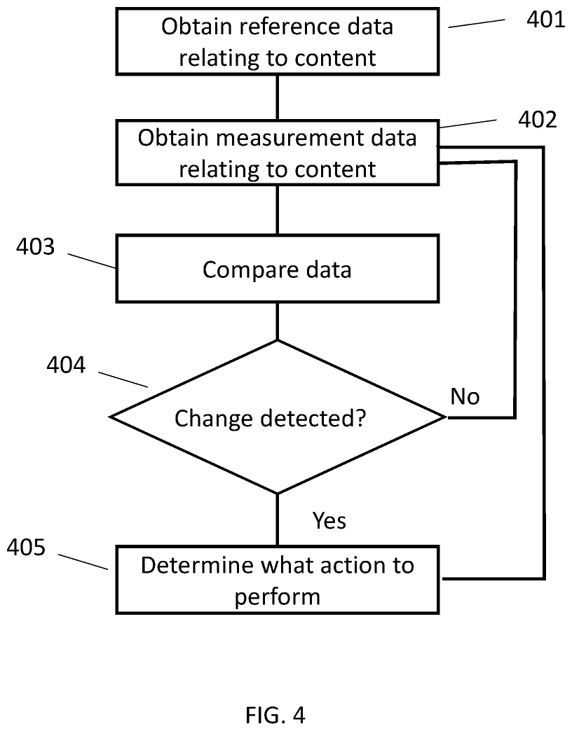

An example of such a monitoring process is shown in FIG. 4. At block 401 reference data relating to content at an identified page (or pages) of memory is obtained. The data may be the content itself or data based on or derived from the data. In an example, the data relating to the content is a cryptographic hash of the memory content. For example, such a hash may be generated according to the SHA-256 hash protocol. This provides a simple measure that takes up a small amount of memory but is suitable for performing the comparison. Cryptographic hash functions are one-way functions that take an arbitrary-length input and output a constant-length hash. One of the guarantees they provide is collision resistance: it is infeasible to find two different inputs that will give the same hash as output. They are thus a good way to verify the integrity of the kernel-executable code without needing to store an entire copy of it. In our specific case, we use the SHA-256 function.

In another example, the memory content at the identified location may be digitally signed with a cryptographic signature, the signature may be obtained and used to make the comparison to determine the authenticity of the content.

In one example, a monitoring component, first computes a reference list of hashes taken just after the boot, during the trusted phase of the kernel boot and setup as the first data relating to the memory content.

The initial measurements (computation of the reference data) may have a crucial place in the security of the monitoring process. Indeed, the process may not be able to differentiate between “good” and “bad” initial measurements: it will just ensure that, during the runtime of the platform, no code is added or modified compared to these initial measurements. It is advantageous, therefore, if these initial measurements (obtaining of the reference data 401) happens as early as possible in the boot process, to minimize the risk of an infection already being present when we take the measurements.

However, they should also be taken after all kernel modules have been loaded. Indeed, because the monitoring process may detect both code modifications and additions, it could detect the loading of a module after the initial measurements have been taken as a malicious code addition.

In an example. the taking of these initial measurements may be integrated with the platform's boot manager. Through proper configuration of the boot manager, it can be made to send a signal, e.g. to a monitoring component, as soon as all kernel modules are loaded, so we can start inspecting the page tables and calculate the initial measurements. Then, at a later point during boot (which can be immediately after we start taking the measurements), but before starting to execute any code that represents a potential risk (e.g. unsigned code, a very large codebase, the network stack . . . ), all initial hash calculations (or other process to obtain the reference data) have been completed. At that point in time during the boot, the monitoring will be fully initialised functional and may continue according to any of the examples described herein.

According to an example, the initial measurements are thus an assembled list of virtual addresses identified as having the predetermined property (e.g. that it is executable by a kernel of an OS) and data such as a hash of at least some of the content at the location.

At block 402, measurement data relating to content at the identified page (or pages) of memory. The measurement data may be obtained in a similar manner to the reference data at block 401. The measurement data is obtained subsequent to the reference data being obtained (e.g. some time after boot up during which the processor has been executing). The reference data is compared with the measurement data at block 403. For example, where a hash has been calculated to obtain the reference data and measurement data it is the respective hash values for a page of memory that are compared. It is determined from the comparison whether there have been any changes to the memory content at the location at block 404. If yes, then processing continues at block 405 where a decision as to whether a mitigating or other action is to be taken or not in response to the detected change. Further, obtaining the measurement data may include reassembling the list of virtual addresses that have the predetermined property according to attributes of the page table entries. If a virtual address in the measurement data is not in the reference list, then this indicates there has been a code addition and a mitigating action may be needed. Thus, a change is detected and processing continues to block 405. Further, according to an example, if a physical address indicated by a page table entry of a virtual address is different in the measurement data than the reference data then this indicates an intrusion and again processing should continue to block 405 to determine what, if any, mitigating action is required.

If for a given virtual address, the measured hash of the code is the same as the reference list, indicating that the integrity of this code is not compromised then, the integrity of the system is still intact and no action is taken. Accordingly, the method can return to block 402 where the monitoring may be resumed.

In addition, once any mitigating actions have been taken processing may return to block 402 and monitoring may continue. Further data is obtained at block 402 as the measurement data and what was used as the measurement data in the previous comparison is now treated as the reference data for the comparison in 403. The further measurement data may be obtained after a predetermined amount of time (or computational cycles) has passed. In this way, the method may continuously and regularly monitor the identified memory locations. In other words, we continuously compute the same hashing (or alternative) operation on the kernel memory during runtime and compare the list of newly measured hashes with the reference list. The interval may be generated and hidden in a secure memory or be non-periodic so as to not be easily predicted by an attacker. Otherwise, it may be possible for a malware or other malicious code to be move in memory before the measurement and successfully evade detection but still remain persistent in the memory. Rather than making the comparison at a predetermined interval, it may be instead that the measurement is caused to repeat based on a trigger event in the system. For example, the measurement and comparison could be made upon, during or after the installation or download of new software or during a context switch between processes.

At block 404, a monitoring component, upon comparing the obtained reference and measurement data (hash values) for a given page address, may take an action based on the following security policy (logic) according to an example.

If at a given virtual address, the monitoring component does not find any code at all (i.e. there is no code to calculate the hash) whereas some code was present in the reference list (i.e. a hash value was calculated in the reference list). In this case, the monitoring component can, according to an example, either silently ignore the discrepancy (as it should not be considered a security threat) or according to another example, apply a policy such as logging of the event. This can happen when dynamic code (such as UEFI runtime services, or driver), get unloaded or otherwise marked as unused.

If, at a given virtual address, the measured (current) hash contains code that was not present in the reference list. This indicates that some new code has been loaded and made executable by the kernel. This could either be due to an attack (e.g. an attacker loading a new kernel module or exploited a kernel vulnerability to perform some code injection), or could be due to a legitimate loading of a driver for instance. In an example, the monitoring component will apply a policy or policies.

According to an example, a policy may allow for all additions to be treated as a threat: In this case, any new addition of code is considered malicious and remedial actions are taken (in a similar way than for code changes event) such as rebooting the system.

According to an example, a policy may allow for all additions may be allowed: In this case, the monitoring component would allow the new code to be executed (maybe securely logging the event). The measured hashes for the new code will be added to the reference list and the kernel will continue its operation. This could be use in the debug or development phase for instance.

According to an example, trusted additions allowed but not un-trusted additions: In this case, the monitoring component will perform further checks on the newly added code before deciding if the new code should be added to the reference list. Such checks could include (but not limited to): Verification of a digital signature based on the driver signature, verification against an “allowed update” hash list, validation by a remote party (e.g. policy server), etc.

At a given virtual address, the measured hashes show code with a different hash than the corresponding hash in the reference list. This shows that some existing code has been modified. This should not happen during normal operation. This is likely a result of a code modification attack (e.g. an attacker modifies a piece of kernel code to remove a privilege check). Accordingly, in an example, the monitoring component reports the error and take a mitigation action (e.g. reboot of the platform). Other possible mitigations include, logging the problem but otherwise doing nothing, reporting the problem to a security operation centre, or freezing operation of the device to allow forensic analysis. This list is not exclusive, however, and other mitigating actions are possible.

According, to an example, an overall policy may be set that includes at least one of or is a combination of any of the above policies.

The monitoring examples above use a very efficient measurement method because it looks at what the kernel can execute (or other memory areas which are identified and deemed at risk) without looking at other irrelevant memory areas, and cannot be misled. This is because CPU is prohibited from executing memory areas that are not marked as executable.

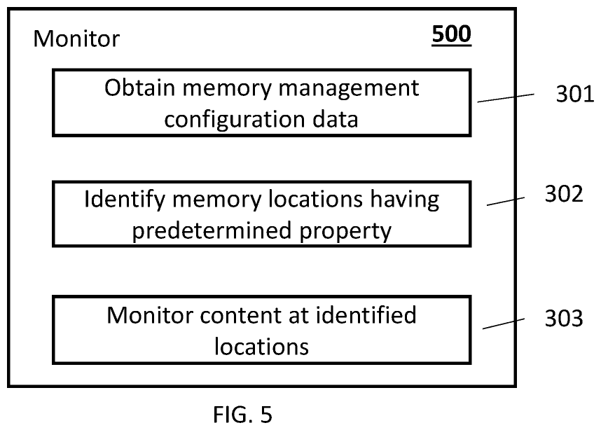

FIG. 5 is a block diagram of a monitoring component 500 according to an example. The monitoring component 500 is to perform the method of FIG. 3 as described above. According to examples, the monitoring component may be implemented as a set of computer readable instructions executing on a processor, a dedicated hardware component or any combination of hardware and software. The monitoring component 500 is to obtain 301 memory management configuration data. For example, the memory management configuration data may be page table data including virtual addresses and attribute information of pages in a virtual memory. The monitoring component is also to identify 302 memory locations (i.e. pages in a virtual memory) having predetermined property. For example, the predetermined property might be that the locations are privileged and executable by a kernel of an O/S. In other words, the monitor 500 may identify if a page table entry of a page table of the memory management unit has a predetermined page table attribute. The monitoring component 500 is further to monitor content at identified locations. The monitoring may be performed according to the method shown in FIG. 4 or any other example described herein, for example. In other words, the monitor 500 may monitor data at the memory location of memory corresponding to a page table entry identified as having the predetermined page table attribute.

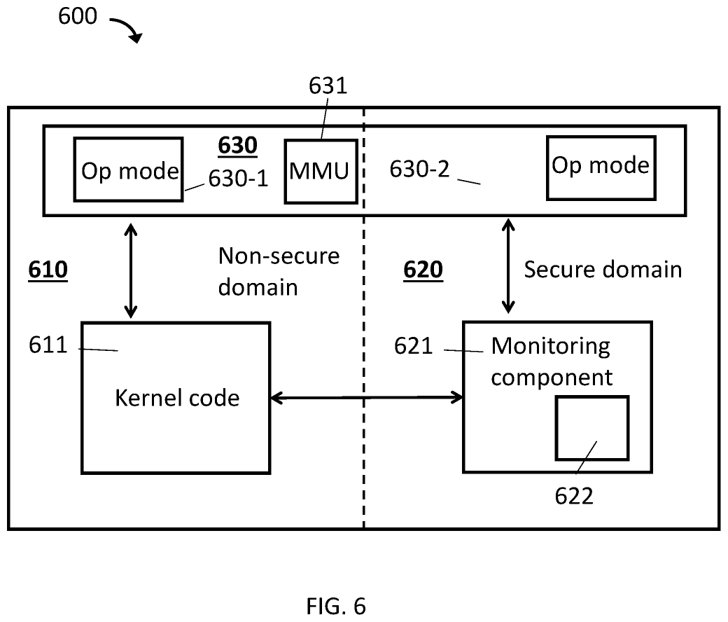

FIG. 6 shows a conceptual schematic of a computing system 600 in which a monitoring component (implementing any of the example processes described above) runs in a privileged and isolated environment. In this example, the secure privileged domain may be referred to as ‘secure world’ 620 and the non-secure domain 610 may be referred to as ‘normal world’ 610. A processor 630 is configured so that has operating modes 630-1, 630-2 for executing processes in the secure world 620 and the normal world 610 respectively. The processor includes an MMU 631 which manages the configuration registers and page tables for the virtual memory space operated in by the processor 630. In this example, the monitoring component 621 is a secure application running in the 620 world and is able to access memory 611 containing O/S kernel software components which are executed in the normal (non-secure domain) world 610. The monitoring component 621 may store the reference list or lists 622 in the secure world thus shielding them from attack.

The isolated environment the monitoring component executes in can be implemented using technologies such as (but not limited to) SMM, TrustZone®, a hypervisor or Virtualization for instance or any other isolated execution environment available to those skilled in the art. Further hardening may be provided by a trusted execution environment executing within the isolated environment. As a result, the monitoring component can perform memory read operation on the memory located in the address space of the kernel but remain isolated from any potential compromise of the kernel. Crucially, the monitoring component can also access the execution context of the monitored kernel (i.e. CPU registers, memory configuration, etc.). In other words, having the monitoring component 621 execute in an isolated environment is more robust than software hardening as it is isolated from the kernel and thus cannot get compromised at the same time as the kernel.

In the example of FIG. 6, the monitoring component 621 is implemented in software, however, in other examples it may be (at least in part) a secure hardware component operating in the secure domain.

In the examples described above, the monitoring process may be performed in either hardware or software. In another example, it is possible to have a hardware block performing the hashing and comparing the hashes with the reference list at boot (i.e. it protects against code modification), and in parallel have software using the MMU to protect against code addition attacks i.e. identifying executable areas of memory and determining when code is present when it was not previously there. In addition, it is possible to determine whether some code has been moved. In other words, check that a given virtual address of relevant code still points to the same physical address. The detection of code addition attacks, thus might not require computationally intensive hashing operations, and can be efficiently executed in software. Other splits between hardware and software would also be possible and could be selected based on the likely complexity, performance and cost criteria to determine an optimal security system.

In examples described above, page table entries and attributes managed by a memory management unit of a processor are used to determine locations of code to be monitored. However, microcontrollers and processors may instead of an MMU and page tables have a “Memory Protection Unit” (MPU). Regions of memory having different properties may be defined by registers of the MPU, which could for example indicate which regions of memory that are executable by a kernel (or other privileged processes). When using an MPU, page tables are not used. Accordingly, both page table attributes (or other MMU memory configuration data) and MPU register values are examples of memory configuration data. Other memory configuration data in other memory management implementations may be possible that indicates a property of memory indicating that it should be monitored.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

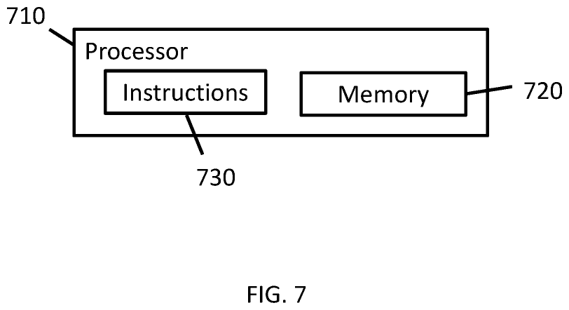

FIG. 7 shows an example of a processor 710 associated with a memory 720. The memory 720 comprises computer readable instructions 730 which are executable by the processor 710. The instructions 730 comprise:

Instructions to assemble a list of pages in memory having a predetermined attribute using page tables of a memory management unit.

Instructions to monitor memory locations of the pages to determine if any change has taken place.

Instructions to determine whether a mitigating action is to be performed based on the monitoring.

In an example, the predetermined attribute is that the memory location is executable by a kernel.

In an example, the predetermined attribute is that the memory location is “read only”.

In an example, the instructions comprise instructions to monitor the memory locations by obtaining first data based on the content at a first time and comparing the first data with second data subsequently obtained based on the content at the identified memory locations.

In an example, the instructions comprise instructions to generate the first and second data by calculating a hash of the content at the identified memory locations.

In an example, the instructions are executed in a privileged or secure environment of the processor. For example, the secure environment may be provided using any of TrustZone, Hypervisor or a System Management Mode (SMM).

In an example, the instructions comprise instructions to determine whether to perform a policy action based on the monitoring.

Such machine readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
obtaining memory management configuration data;
using the memory management configuration data to identify memory locations having a predetermined property;
monitoring content at the identified memory locations

2. The method according to claim 1, wherein the predetermined property is that the memory location is executable by a kernel.

3. The method according to claim 1, wherein the predetermined property is that the memory location is read only.

4. The method according to claim 1, wherein the monitoring comprises obtaining first data based on the content at a boot up and comparing the first data with second data subsequently obtained based on the content at the identified memory locations.

5. The method according to claim 4, wherein the first and second data includes a hash of the content at the identified memory locations.

6. The method according to claim 1, wherein the method is performed using a monitoring component in an isolated environment.

7. The method according to claim 6 wherein the isolated environment is provided using any of TrustZone, Hypervisor or a System Management Mode (SMM).

8. The method according to claim 1, further comprising determining whether to perform a policy action based on the monitoring.

9. The method according to claim 8, further comprising, where the monitoring indicates that new code has been added to the identified memory location, performing a verification to determine whether the added code is valid

10. Apparatus comprising a monitor and a processor, the monitor being to:
identify if memory region attributes associated with a memory region addressable by the processor has a predetermined attribute:
monitor data at a memory region based on having the predetermined page table attribute.

11. Apparatus according to claim 10, wherein the monitor belongs to an isolated computing environment and the memory region attributes belong to a non-isolated computing environment.

12. Apparatus according to claim 11, wherein the monitor is further to assemble a list of executable pages from the identified memory region attributes and to monitor the data by computing a hash of content of those pages.

13. Apparatus according to claim 11, wherein the attribute is identified from memory configuration registers or page table attributes associated with the memory region.

14. Apparatus according to claim 12, wherein the attribute is that the memory region is for privileged code.

15. A non-transitory machine-readable storage medium encoded with instructions executable by a processor, the machine-readable storage medium comprising instructions to:
assemble a list of memory locations in a memory having a predetermined attribute using memory configuration data;
monitor the memory locations of the list to determine if a change has taken place; and
determine whether a mitigating action is to be performed based on the monitoring.
